(19) United States
(12) Patent Application Publication
(10) Pub. No.: US 2014/0336302 A1
(43) Pub. Date: Nov. 13, 2014

(54) CURABLE WATER SOLUBLE EPOXY ACRYLATE RESIN COMPOSITIONS

(71) Applicant: Dow Global Technologies LLC, Midland, MI (US)

(72) Inventors: E. Joseph Campbell, Missouri City, TX (US); Anthony P. Gies, Lake Jackson, TX (US)

(21) Appl. No.: 14/361,344

(22) PCT Filed: Dec. 18, 2012
(86) PCT No.: PCT/US2012/070224

§ 371 Date: May 29, 2014

Related U.S. Application Data
(60) Provisional application No. 61/581,147, filed on Dec. 29, 2011.

(51) Int. Cl. C08G 59/24

(52) U.S. Cl. CPC C08G 59/245
USPC 522/170; 525/531

(57) ABSTRACT

A water soluble epoxy acrylate resin composition including a reaction product of (a) at least one diepoxide resin or a diepoxide resin blended with other epoxy resins; (b) at least one carboxylic acid; and (c) at least one basic reagent in an amount sufficient to form a water soluble epoxy acrylate resin product; a process for preparing the above water soluble epoxy acrylate resin composition; a curable water soluble epoxy acrylate resin composition including (i) the epoxy acrylate resin composition described above, and (ii) at least one initiator; a process for preparing the curable water soluble epoxy acrylate resin composition described above; a process for curing the curable water soluble epoxy acrylate resin composition described above; and a cured product made therefrom.

### BACKGROUND OF THE INVENTION

1. Field of the Invention

The present invention is related to curable water soluble epoxy acrylate resin compositions and products made from the curable compositions.

2. Description of Background and Related Art

The use of pentaerythritol, 2,2-dihydroxymethylpropionic acid (DMPA), toluene-2,4-diisocyanate (TDI), 2-hydroxy-2-methyl-1-phenyl-1-propanone (HMPP) and maleic anhydride as raw materials to prepare hyperbranched macromolecular photoinitiators is disclosed in Wang, Junxia; Zhang, Li; Shi, Guang; Synthesis and characterization of hyperbranched macromolecular photoinitiator for waterborne UV-curable coatings; School of Chemistry and Environment; South China Normal University; Guangzhou, Peop. Rep. China; Tuliao Gongye (2010); 40 (7); 1-4, 9; incorporated herein by reference. The photoinitiators described in the above reference could be used in a UV-curing process. The reference above discloses that 4 percent (%) of initiator content gave the best result. The reference above further discloses that macromolecular photoinitiators showed little solubility in pure (non-alkaline) water, but could be miscible in UV-curing systems containing an alkali neutralizer.

Wang, Feng; Zhang, Hongbin; Tu, Weiping; Hu, Jianqing; Sulfonic acid-type UV-curable waterborne epoxy emulsion and its preparation method; Faming Zhuanli Shenqing; (2010); 7pp; CODEN: CNXXEV CN 101914171 A 20101215 CAN 154:66781 AN 2010:1576419; incorporated herein by reference, discloses a method which comprises the following steps: (1) allowing ring-opening esterification of epoxy resin (E-51 or E-44) and maleic anhydride (at a molar ratio of 1:2-2.1) at 90° C.-120° C. for 3 hours-5 hours to give epoxy maleate, (2) heating the epoxy maleate at 50° C.-90° C., adding PCl₃ (at epoxy maleate/PCl₃ molar ratio of 1:0.5-2), reacting at 50° C.-90° C. for 2 hours-3 hours to gain epoxy fumaryl chloride, (3) adjusting the pH of an aminosulfonic acid (e.g., p-aminobenzenesulfonic acid or taurine) to 8-10 with NaOH alcohol solution, (4) reacting the epoxy fumaryl chloride and the aminosulfonic acid at 50° C.-80° C. for 1 hour-3 hours, and (5) dispersing the resultant reaction product in water.

Li, Gang; Shen, Feng; Deng, Yudong; Aqueous UV-curable varnish oil for paper glazing; Faming Zhuanli Shenqing; (2010); 7pp; CODEN: CNXXEV CN 101798775 A 20100811 CAN 153:336633 AN 2010:1028836; incorporated herein by reference, discloses a paper varnish oil which comprises a water-dispersible epoxy resin diacrylate oligomer 10-45%, a water-dispersible polyurethane diacrylate oligomer 10-45%, a water-soluble acrylic resin 20-45%, an aqueous dispersant 0.1-0.5%, an aqueous defoaming agent 0.05-0.50%, a paraffin wax emulsion 5-20%, a UV initiator 1-5%, and deionized water 30-50%. The paper varnish oil is prepared through adding the raw material in a certain sequence, stirring at 50-100 Hz for uniformly dispersing, and discharging.

A coating material consisting of modified acrylic polyurethane 20-50%, initiator 5-15%, surface modifier 1-2%, co-solvent 5-10%, and water 25-65% is disclosed in Li, Zhimin; Water-thinned coating material of UV-cured vacuum-plating base coating; Faming Zhuanli Shenqing Gongkai Shuomingshu; (2010); 8pp; CODEN: CNXXEV CN 101787243 A 20100728 CAN 153:289129 AN 2010:952705; incorporated herein by reference.

The systems of the prior art are not truly water soluble and are either (1) dispersed in water via emulsion; or (2) require either (a) alkali metals or (b) co-solvents to make the curable resin miscible.

### SUMMARY OF THE INVENTION

One aspect of the present invention is directed to a curable water soluble system and a process for preparing curable water soluble epoxy acrylate resin monomers. The present invention described herein includes the preparation or isolation of curable water-soluble epoxy acrylate resins systems particularly employing a diepoxide compound such as a divinylarene dioxide.

The problems of the prior art are addressed by the curable water soluble epoxy acrylate resin compositions of the present invention which utilizes liquid epoxy acrylate resins such as for example epoxy acrylate resins derived from diepoxides including for example a divinylarene dioxide such as divinylbenzene dioxide (DVBDO); and more specifically, to acrylic and methacrylic acid derivatives of divinylarene diepoxides and aliphatic diepoxides.

One embodiment of the present invention is directed to epoxy acrylate resin compositions, especially for example diepoxide derivatives, including a reaction product of (a) at least one diepoxide resin such as for example DVBDO, or a diepoxide resin blended with other epoxy resins; (b) at least one carboxylic acid; and (c) at least one basic reagent in an amount sufficient to form a water soluble epoxy acrylate resin product. For example, the basic reagent can be an amine or a phosphine including a primary, secondary or tertiary amine or phosphine. In one embodiment, the amount of basic reagent used may be at least 0.5 equivalents (0.5 to 1 ratio to diepoxide compound) of for example a primary, secondary or tertiary amine.

Another embodiment of the present invention is directed to a process for preparing the above epoxy acrylate resin compositions derived from diepoxide resins wherein the process comprises reacting (a) at least a diepoxide resin such as for example DVBDO, or a diepoxide resin blended with another epoxy resin which is different from the diepoxide; (b) at least one carboxylic acid; and (c) at least one basic reagent in an amount sufficient to form a water soluble epoxy acrylate resin product.

Still another embodiment of the present invention is directed to epoxy acrylate resin compositions, especially for example diepoxide derivatives, including a reaction product of (a) at least one diepoxide resin such as for example DVBDO, or a diepoxide resin blended with another epoxy resin which is different from the diepoxide; (b) at least one monocarboxylic acid; (c) at least one di-, tri- or higher functionality carboxylic acid; and (d) at least one basic reagent in an amount sufficient to form a water soluble epoxy acrylate resin product. For example, the basic reagent may be at least tertiary amine.

Yet another embodiment of the present invention is directed to a process for preparing the above epoxy acrylate resin compositions derived from diepoxide resins wherein the process comprises reacting (a) at least a diepoxide resin such as for example DVBDO, or a diepoxide resin blended with other epoxy resins; (b) at least one monocarboxylic acid; (c) at least one di-, tri- or higher functionality carboxylic acid; and (d) at least one basic reagent in an amount sufficient to form a water soluble epoxy acrylate resin product.

Even yet another embodiment of the present invention is directed to a curable water soluble epoxy acrylate composition including (i) the curable water soluble epoxy acrylate resin composition described above, and (ii) at least one initiator. The curable water soluble epoxy acrylate resin composition may also optionally include reactive and non-reactive diluents or other additives.

Other embodiments of the present invention include a process for making the above-described curable water soluble epoxy acrylate resin composition; and a process for curing the water soluble epoxy acrylate resin composition.

### DETAILED DESCRIPTION OF THE INVENTION

### Definitions

By “water-soluble” in reference to a composition herein, it is meant that at a minimum of 10 weight percent (wt %) of the solute can be mixed with water (e.g., 85 wt %) at room temperature and atmospheric pressure and form one homogeneous phase. In most cases the water solubility is greater than 50 wt %.

By “curable water soluble” in reference to a composition herein, it is meant that any composition that can be dissolved in de-ionized water (as little as 10 wt % in water), and when mixed with an initiator and subjected to UV light or heat will polymerize and cure.

“Multifunctional carboxylic acid” herein means any di, tri or higher functional compound with more than one carboxylic acid functionality.

For the purpose of illustrating the present invention and without being limited thereto, several specific embodiments of the present invention may be shown by the following chemical structures.

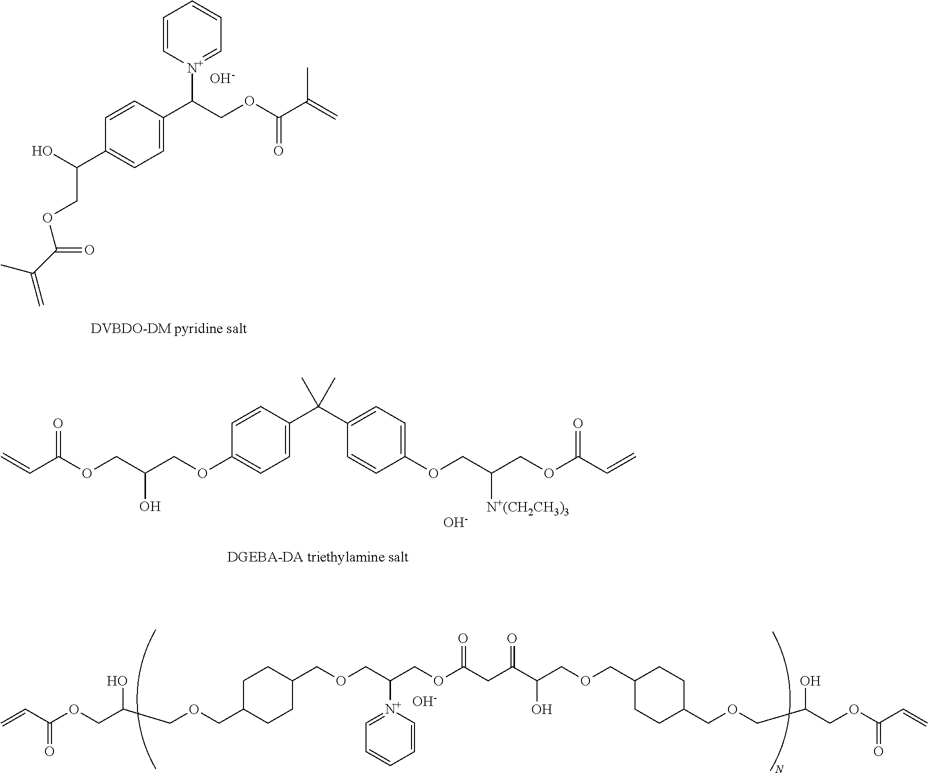

### Malonic Acid Oligomer of Cyclohexanedimethanol Diglycidylether-DA Pyridine Salt

For example, the reaction scheme for preparing the epoxy acrylate resin composition of the present invention which is useful in preparing a curable water-soluble composition can be illustrated by the following reaction Scheme 1:

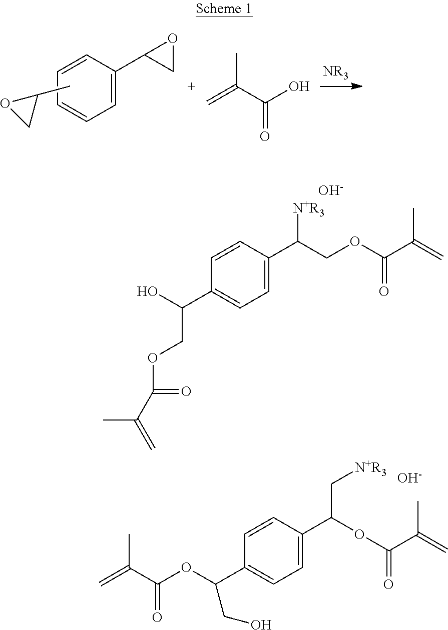

A second broad embodiment of the present invention is directed to a curable water-soluble composition including the reaction product of: (a) at least a diepoxide resin such as for example cyclohexyldimethanol diglycidylether or DVBDO, or a diepoxide resin blended with other epoxy resins; (b) at least one carboxylic acid; (c) at least one amine; and (d) at least one di or higher multi-functional carboxylic acid.

The reaction scheme for preparing the epoxy acrylate resin composition of the present invention which is useful in preparing a curable water soluble composition can be illustrated by the following reaction Scheme 2:

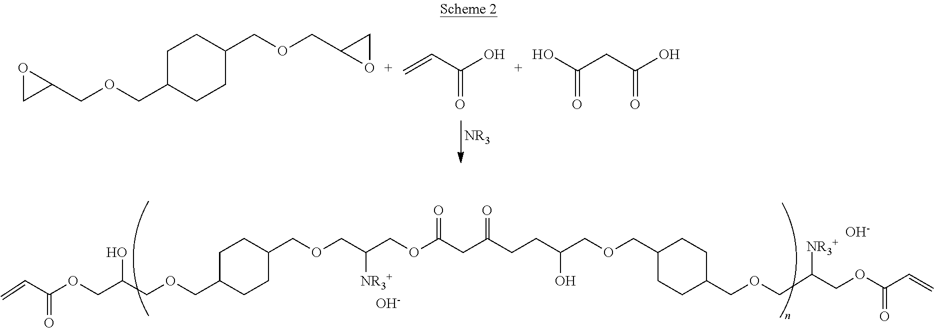

The diepoxide compound for preparing the epoxy acrylate resin composition of the present invention may comprise for example any substituted or unsubstituted aliphatic, cycloaliphatic or aryl diepoxides. Additional substituents may consist of saturated alkyl, aryl, halogen, nitro, isocyanate, or RO— (where R may be a saturated alkyl or aryl). Ring-annulated benzenes may consist of naphthalene, tetrahydronaphthalene, and the like. Homologously bonded (substituted) benzenes may consist of biphenyl, diphenylether, and the like.

In one embodiment, the diepoxide useful in the present invention comprises for example a divinylarene dioxide such as DVBDO, a low viscosity liquid epoxy resin having for example a viscosity in the range of from about 0.001 Pas to about 0.1 Pas at 25° C.

The concentration of the diepoxide used in the present invention as the epoxy resin portion of the formulation may range generally from about 0.5 wt % to about 80 wt % in one embodiment from about 10 wt % to about 70 wt % in another embodiment, from about 20 wt % to about 65 wt % in still another embodiment, and from about 25 wt % to about 55 wt % in yet another embodiment, depending on the fractions of the other formulation ingredients and based on the weight of the total composition.

Carboxylic acids compounds of the present invention may include any conventional unsaturated monocarboxylic acid known in the art. For example, suitable unsaturated monocarboxylic acids for reaction with the diepoxide compounds include acrylic acid, methacrylic acid, cyanoacrylic acid, crotonic acid, alpha-phenylacrylic acid, methoxyacrylic acid, alpha-4-phenylphenylacrylic acid, monomethylester of maleic acid, and monomethylester of fumaric acid,

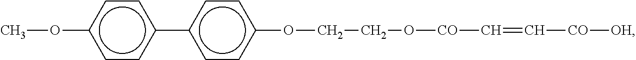

or mixtures thereof.

Mixtures of any two or more monocarboxylic acids can also be used in the practice of the present invention. Suitable monocarboxylic acid compounds useful in the present invention are described for example in U.S. Pat. No. 5,164,464; incorporated herein by reference.

In one preferred embodiment of the present invention, an epoxy acrylate resin composition can be prepared for example by using a monocarboxylic acid compound including for example methacrylic acid, acrylic acid or mixtures thereof.

In another preferred embodiment, the carboxylic acid used in the present invention may be acrylic acid, acetic acid, or mixtures thereof.

In one embodiment, a mole ratio of from about 0.01:1 to about 6:1 of unsaturated monocarboxylic acid per diepoxide is used; in another embodiment a mole ratio of from about 0.5:1 to about 4:1 of monocarboxylic acid to diepoxide is used; and in still another embodiment a mole ratio of from about 1:1 to about 2.5:1 of monocarboxylic to diepoxide is used.

Any basic reagent such as amines or phosphines known in the art may be used in the composition of the present invention including for example pyridine, trimethylamine, triethylamine, tricyclohexylphosphine, triphenylphosphine, triethoxyphosphine, and mixtures thereof.

The mole ratio of the amine or phosphine to diepoxide used to prepare the epoxy acrylate resin composition of the present invention may range generally from about 0.1:1 to about 3:1 in one embodiment; from about 0.25:1 to about 2:1 in another embodiment; and from about 0.5:1 to about 1.25:1 in still another embodiment.

In one illustrative embodiment, 2.5 equivalents methacrylic acid are used with 1.1 equivalents of amine, and 1 equivalent DVBDO; and optionally in a solvent such as toluene at 40 wt %.

Multifunctional carboxylic acids of the present invention may optionally be used in the present invention. For example, suitable multifunctional carboxylic acids may include any conventional any di, tri or higher functional carboxylic acid compounds known in the art. For example, suitable multifunctional carboxylic acids for reaction with the diepoxide compounds include oxalic, malonic succinic, glutaric, adipic, citric, aconitic and mixtures thereof.

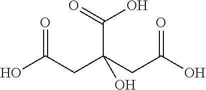 [SMILES: O=C(O)CC(O)(CC(=O)O)C(=O)O]

Mixtures of any two or more carboxylic acids can also be used in the practice of the present invention.

In one preferred embodiment, the multifunctional carboxylic acid used in the present invention may be malonic or oxalic acid or mixtures thereof.

In general, a mole ratio of from about 0.01:1 to about 1:1 of total OH carboxylic acid per epoxide group in the diepoxide compound is used in one embodiment of the present invention; and a mole ratio of from about 0.1:1 to about 0.8:1 of total OH carboxylic acid to epoxide is used in another embodiment of the present invention; and from about 0.3:1 to about 0.6:1 of total OH carboxylic acid to epoxide is used in still another embodiment.

In one illustrative embodiment, 0.6 equivalents acrylic acid and 0.7 equivalents of malonic acid are used with 1.3 equivalents of triethylamine, and 1 equivalent DVBDO, optionally in a solvent such as a blend of toluene and tetrahydrofuran (THF) at 40 wt %.

The reaction to produce the epoxy acrylate resin composition of the present invention is optionally conducted in one or more organic solvents inert to the other reactants. The optional solvent used to facilitate the reaction of the diepoxide compound with the at least one (meth)acrylic acid compound and at least one amine compound such pyridine may include for example, one or more conventional organic solvents well known in the art. For example, aromatic hydrocarbons such as toluene or xylene; ketones such as methyl ether ketone; ethers such as diglyme; the chlorinated aliphatics such as perchloroethylene; and mixtures thereof, may be used in the present invention. The term “inert” as applied to the organic solvent means that little, if any, reaction between the divinylarene dioxide compound, the monounsaturated monocarboxylic acid or the epoxies thereof occurs under the reaction conditions employed.

The concentration of the solvent used in the present invention may range generally from 0 wt % to about 90 wt % in one embodiment, from about 0.01 wt % to about 80 wt % in another embodiment, from about 1 wt % to about 65 wt % in still another embodiment; and from about 10 wt % to about 50 wt % in yet another embodiment.

The diepoxide used in the present invention may be used as the sole epoxy resin component in the curable composition of the present invention; or the diepoxide may be used in combination with other epoxy resins known in the art such as epoxy resins described in Lee, H. and Neville, K., Handbook of Epoxy Resins, McGraw-Hill Book Company, New York, 1967, Chapter 2, pages 2-1 to 2-27, incorporated herein by reference. Particularly suitable epoxy resins other than the divinylarene dioxide may include for example epoxy resins based on reaction products of polyfunctional alcohols, phenols, cycloaliphatic carboxylic acids, aromatic amines, or aminophenols with epichlorohydrin. A few non-limiting embodiments include, for example, bisphenol A diglycidyl ether, bisphenol F diglycidyl ether, resorcinol diglycidyl ether, and triglycidyl ethers of para-aminophenols. Other suitable epoxy resins known in the art include for example reaction products of epichlorohydrin with o-cresol and, respectively, phenol novolacs. It is also possible to use a mixture of two or more other epoxy resins with the divinylarene dioxide. The other epoxy resin may also be selected from commercially available products such as for example, D.E.R. 331®, D.E.R.332, D.E.R. 334, D.E.R. 580, D.E.N. 431, D.E.N. 438, D.E.R. 736, or D.E.R. 732 epoxy resins available from The Dow Chemical Company.

When one or more other epoxy resin(s) is used in the composition of the present invention in combination with the diepoxide, the concentration of the sum of the epoxy resins may be generally from about 0.5 wt % to about 80 wt % in one embodiment from about 10 wt % to about 70 wt % in another embodiment, from about 20 wt % to about 65 wt % in still another embodiment, and from about 25 wt % to about 55 wt % in yet another embodiment, depending on the fractions of the other formulation ingredients and based on the weight of the total composition.

The preparation of the epoxy acrylate resin composition of the present invention is achieved by adding to a reactor: a diepoxide, a (meth)acrylic acid, and an amine base and optionally a solvent and/or a multifunctional carboxylic acid; and then allowing the components to react under reaction conditions to produce the epoxy acrylate resin composition product. The components are heated until the desired degree of reaction is achieved. The resulting reaction product is allowed to cool, and then the organic solvent is decanted from the oily layer such that the product may be immediately used in thermoset formulations.

The reaction conditions to form the epoxy acrylate resin composition include carrying out the reaction under a temperature, generally in the range of from about 50° C. to about 250° C. in one embodiment; from about 60° C. to about 150° C. in another embodiment; and from about 75° C. to about 110° C. in still another embodiment.

The pressure of the reaction may be generally from about 0.1 bar to about 10 bar in one embodiment; from about 0.5 bar to about 5 bar in another embodiment; and from about 0.9 bar to about 1.1 bar in still another embodiment. The reaction to produce the epoxy acrylate resin composition is usually conducted generally at a reaction time of from about 20 minutes to about 8 hours in one embodiment, and from about 60 minutes to about 6 hours in another embodiment. Although reaction times and reaction temperatures can vary substantially, the epoxy acrylate resin compositions of the present invention are produced by reacting the reactants to a specific conversion, typically to a conversion of from about 1.5% to about 0.25% epoxide acid left in the reaction.

The reaction process to prepare the epoxy acrylate resin composition of the present invention may be a batch or a continuous. The reactor used in the process may be any reactor and ancillary equipment well known to those skilled in the art.

The epoxy acrylate resin composition, the reaction product of diepoxides, (meth)acrylic acids, amines and/or phosphines and/or multi-functional carboxylic acid are water soluble (as much as for example 75 wt % in water) and have a lower viscosity compared to similar epoxy resins of the prior art.

The viscosity of the epoxy acrylate resin composition prepared by the process of the present invention ranges generally from about 50 cP to about 5000 cP in one embodiment; from about 100 cP to about 25000 cP in another embodiment; and from about 200 cP to about 1500 cP at 25° C. in still another embodiment.

The number average molecular weight (Mₙ) of the epoxy acrylate resin composition prepared by the process of the present invention ranges generally from about 200 to about 100,000 in one embodiment; from about 300 to about 10,000 in another embodiment; and from about 500 to about 2,500 in still another embodiment.

The epoxy acrylate resin composition reaction product of the present invention is useful as the epoxy component in a curable water soluble UV-thermosettable or a UV-curable resin formulation or composition as described herein.

In another broad embodiment of the present invention, the epoxy acrylate resin composition described above may be mixed with an initiator to form a curable water soluble resin composition. In accordance with this embodiment, a curable water soluble resin composition includes (i) the epoxy acrylate resin composition reaction product described above, and (ii) at least one initiator.

The epoxy acrylate resin composition reaction product of the curable water soluble resin composition of the present invention comprises the epoxy acrylate resin composition reaction product described above

Generally, the quantity of (i) epoxy acrylate resin composition used to prepare the curable water soluble resin composition of the present invention may include from about 85 wt % to about 99.9 wt % in one embodiment. In another embodiment, the composition may include from about 85 wt % to about 95 wt % of (i) epoxy acrylate resin composition; and from about 80 wt % to about 90 wt % of (i) epoxy acrylate resin composition in still another embodiment.

The initiator useful for making a curable water soluble resin composition of the present invention may comprise any conventional initiator known in the art for curing epoxy acrylate resins. The initiators useful in the curable or thermosettable composition may include, for example, benzophenone-1-hydroxy cyclohexyl phenyl ketone mixture (such as Irgacure 500 commercially available from BASF); phenylglyoxylate photoinitiator (such as DAROCUR MBF commercially available from Ciba), or mixtures thereof.

Generally, the quantity of the initiator used to prepare the curable water soluble resin composition of the present invention may include from about 0.1 wt % to about 15 wt % in one embodiment. In another embodiment, the composition may include from about 1 wt % to about 10 wt % of initiator, and from about 2.5 wt % to about 5 wt % initiator in still another embodiment.

The curable water soluble resin composition of the present invention may include other additives such as water and other unreactive and/or reactive diluents, catalysts, toughening agents, stabilizers, other resins, fillers, inert fillers, plasticizers, catalysts, catalyst de-activators, inhibitors, curing inhibitors, initiators, curing initiators, flow modifiers, impact modifiers, pigments, colorants, dyes, matting agents, degassing agents, flame retardants (e.g., inorganic flame retardants, halogenated flame retardants, and non-halogenated flame retardants such as phosphorus-containing materials), thermoplastics, thermoplastic particles, processing aids, UV blocking compounds, fluorescent compounds, UV stabilizers, fibrous reinforcements, antioxidants, and mixtures thereof

In general, the curable water soluble resin composition may include from about 0.1 wt % to about 95 wt % of the other optional additives. In other embodiments, the curable water soluble resin composition may include from about 5 wt % to about 95 wt % other additives; from about 40 wt % to about 90 wt % other additives in still other embodiments; from about 50 wt % to about 85 wt % other additives in yet other embodiments; and from about 55 wt % to about 80 wt % other additives in even still other embodiments.

Preparation of the curable water soluble composition of the present invention is achieved by admixing in a vessel the following components: an epoxy acrylate resin composition as described above, a curing agent, optionally a curing catalyst, optionally another epoxy resin, and optionally water as solvent; and then allowing the components to formulate into an epoxy acrylate resin composition. There is no criticality to the order of mixture, i.e., the components of the formulation or composition of the present invention may be admixed in any order to provide the thermosettable composition of the present invention. Any of the above-mentioned optional assorted formulation additives, for example fillers, may also be added to the composition during the mixing or prior to the mixing to form the composition.

All the components of the curable water soluble resin composition are typically mixed and dispersed at a temperature enabling the preparation of an effective water soluble resin composition having a low viscosity for the desired application. The temperature during the mixing of all components may be generally from about 0° C. to about 100° C. in one embodiment, and from about 20° C. to about 50° C. in another embodiment.

The curable water soluble resin composition of the present invention, prepared from the diepoxides described above, lower viscosity at the same heat resistance compared to known compositions in the art and are water soluble in as much as for example 65-75 wt % in water.

The curable water soluble resin formulation or composition of the present invention can be cured under conventional processing conditions to form a thermoset. The resulting thermoset displays excellent thermo-mechanical properties, such as good toughness and mechanical strength, while maintaining high thermal stability.

The process to produce the thermoset products of the present invention may be performed by gravity casting, vacuum casting, automatic pressure gelation (APG), vacuum pressure gelation (VPG), infusion, filament winding, lay up injection, transfer molding, prepregging, dipping, coating, spraying, brushing, and the like.

The curing reaction conditions include, for example, carrying out the reaction under a temperature, generally in the range of from about 0° C. to about 300° C. in one embodiment; from about 20° C. to about 250° C. in another embodiment; and from about 50° C. to about 200° C. in still another embodiment.

The pressure of the curing reaction may be carried out, for example, generally at a pressure of from about 0.01 bar to about 1000 bar in one embodiment; from about 0.1 bar to about bar 100 in another embodiment; and from about 0.5 bar to about 10 bar in still another embodiment.

The curing of the water soluble resin composition may be carried out, for example, for a predetermined period of time sufficient to cure the composition. For example, the curing time may be chosen generally between about 1 minute to about 24 hours in one embodiment, between about 10 minutes to about 12 hours in another embodiment, and between about 100 minutes to about 8 hours in still another embodiment.

The curing process of the present invention may be a batch or a continuous process. The reactor used in the process may be any reactor and ancillary equipment well known to those skilled in the art.

In one illustrative embodiment of the present invention for example, the curable water soluble resin composition of the present invention may be thermally-cured at from about 80° C. up to about 200° C. for a time of 4 hours at atmospheric pressure.

The curable water soluble compositions of the present invention are useful for example in coatings applications requiring low volatile organic compound (VOC) technology and/or in environmentally-friendly applications that need to use an aqueous media.

### EXAMPLES

The following examples and comparative examples further illustrate the present invention in detail but are not to be construed to limit the scope thereof.

In the following Examples, various terms and designations are used such as for example: “RT” which stands for room temperature; “DGEBA” which stands for diglycidyl ether of bisphenol A; “DVBDO” which stands for divinylbenzene dioxide; “DM” which stands for dimethacrylic acid; and “DA” which stands for diacrylic acid.

In the following Examples, standard analytical equipment and methods are used such as for example, ¹H, ESI-MS.

¹H-NMR were recorded on a Bruker AVANCE NMR instrument (250 MHz for ¹H). ¹H NMR data are reported as follows: chemical shift, (multiplicity, integration and peak ID). ¹H-NMR are reported in ppm downfield from tetramethylsilane (TMS, δ scale) with solvent resonance as internal standard. ESI Mass Spectra were obtained using a Waters LCT Premier XE electrospray ionization time-of-flight mass spectrometer (ESI-TOF MS) (Waters, Millford, Mass.). Mass spectra were obtained in the positive ion mode with the capillary (1500 V), cone (ranging from 20 V to 140 V, where needed), source temperature (110° C.), desolvation chamber (250° C.) and TOF mass analyzer potentials optimized to achieve the best signal-to-noise ratio.

### Example 1

In a 250 mL round bottom flask equipped with a reflux condenser and stir bar was added methacrylic acid (19.1 grams, 0.22 mol), pyridine (9.0 grams, 0.11 mol), toluene (60 grams) and divinylarene dioxide (16.4 grams, 0.10 mol). The solution was stirred at 110° C. After 20 minutes a second layer began to form. The reaction was allowed to stir for 4 hours and then allowed to cool to RT. The organic layer was decanted and the resulting oil was washed with toluene (2×, 50 mL). The product was identified as DVBDO-DM pyridinium salt (1150 cPs at 25° C.) and the isolated yield=96%. ¹H-NMR (250 MHz, D₂O): δ 9.15 (b, 1H, N⁺—CH′H″—CH₂CH), 8.88 (m, 1H, N⁺—CH′H″—CH₂CH), 8.65 (m, 1H, N⁺—CH′H″—CH₂CH), 8.15 (m, 2H, N⁺—CH₂—CH₂CH), 7.39 (m, 4H, DVBDO ArH), 6.15 (m, 1H, Ar—CH(CH₂)—N⁺), 5.84 (s, 2H, H₂C═C(CH₃)—), 5.65 (m, 1H, Ar—CH(CH₂)—OH), 5.35 (s, 2H, H₂C═C(CH₃)—), 5.07-4.28 (m, 4H, Ar—CH—CH₂—OC(CH₃)═CH₂), 1.90 (s, 6H, H₂C═C(CH₃)—). ESI-MS Calculated for C₂₃H₂₇NO₆ 396.18. Found 396.18.

### Example 2

In a 250 mL round bottom flask equipped with a reflux condenser and stir bar was added acrylic acid (45.0 grams, 0.63 mol), triethylamine (55.0 grams, 0.54 mol), toluene (250 grams) and DGEBA (100 grams, 0.29 mol). The solution was stirred at 110° C. After 45 minutes a second layer began to form. The reaction was allowed to stir for 6 hours and then allowed to cool to RT. The organic layer was decanted and the resulting oil was washed with toluene (2×, 100 mL). The product was identified as DGEBA-DA triethylamine salt (2148 cPs at 25° C.) and the isolated yield=85%. ESI-MS Calculated for C₂₃H₂₇NO₆ 568.32. Found 546.32.

### Example 3

In a 50 mL round bottom flask equipped with a reflux condenser and stir bar was added acrylic acid (0.18 grams, 2.30 mmol), pyridine (0.45 grams, 6.0 mmol), toluene (2.6 grams), THF (1.4 grams), malonic acid (0.27 grams, 2.6 mmol) and cyclohexanedimethanol diglycidylether (1.00 grams, 3.9 mmol). The solution was stirred at 95° C. After 20 minutes a second layer began to form. The reaction was allowed to stir for 6 hours and then allowed to cool to RT. The organic layer was decanted and the resulting oil was washed with toluene (2×, 100 mL). The product was identified as the malonic acid oligomer of cyclohexane dimethanol-DA pyridinium salt and the isolated yield=90%. ¹H-NMR (250 MHz, D₂O): δ 8.68 (d, 2H, N⁺—CH═CH—CH), 8.44 (t, 1H, N⁺—CH═CH—CH), 7.90 (t, 2H, N⁺—CH═CH—CH), 5.92 (m, 0.63H, CH═CH₂), 5.52 (dod, 0.31H, H₂C═CH), 4.8-3.0 (CH—O, CH—OH), 2.0-0.8 (m, 10H, cyclohexyl H).

### Example 4

In a 50 mL round bottom flask equipped with a reflux condenser and stir bar was added acrylic acid (0.07 grams, 1.0 mmol), pyridine (0.45 grams, 6.0 mmol), toluene (2.6 grams), THF (1.4 grams), malonic acid (0.35 grams, 3.0 mmol) and cyclohexanedimethanol diglycidylether (1.00 grams, 3.9 mmol). The solution was stirred at 95° C. After 20 minutes a second layer began to form. The reaction was allowed to stir for 6 hours and then allowed to cool to RT. The organic layer was decanted and the resulting oil was washed with toluene (2×, 100 mL). The product was identified as the malonic acid oligomer of cyclohexane dimethanol-DA pyridinium salt and the isolated yield=90%. ¹H-NMR (250 MHz, D₂O): δ 8.68 (d, 2H, N⁺—CH═CH—CH), 8.44 (t, 1H, N⁺—CH═CH—CH), 7.90 (t, 2H, N⁺—CH═CH—CH), 5.92 (m, 0.38H, —CH═CH₂), 5.52 (dod, 0.18H, —H₂C═CH), 4.8-3.0 (CH—O, CH—OH), 2.0-0.8 (m, 10H, cyclohexyl H).

### Examples 5-8

DVBDO (1 equiv), acrylic acid (2 equiv) and toluene (or THF 50/50) were mixed inside a 30 mL vial with 2 equivalents of a basic reagent listed in Table I; and the resultant mixture was stirred at 95° C. for five hours and allowed to react. Each of the reactions was allowed to cool to RT and any oil that precipitated from the organic solvent was analyzed by ¹H-NMR. The percent yield of each of the reactions of Examples 5-8 was measured and is described in Table I.

TABLE I
Results for Synthesis of DVBDO-DA Amine and Phosphine Salts

| Example | Basic Reagent | Yield (%) |
|---|---|---|
| 5 | trimethylamine | 94 |
| 6 | triethylamine | 97 |
| 7 | triphenylphosphine | 73 |
| 8 | triethoxyphosphine | 65 |

### Comparative Examples A-D

In these comparative examples listed in Table II, the same reaction process described in Examples 5-8 above were carried out except that the basic reagent used was as described in Table II. The results are also described in Table II which show that no DVBDO-DA amine and/or phosphine salts were made with the basic reagent used.

TABLE II
Comparative Results

| Comparative | | |
|---|---|---|
| Example | Basic Reagent | Yield (%) |
| A | 2-oxazolidone | 0 |
| B | 2-pyrolidone | 0 |
| C | diisopropyl phosphate | 0 |
| D | triphenylphosphite | 0 |

1. A water soluble epoxy acrylate resin composition comprising a reaction product of (a) at least one diepoxide resin; (b) at least one carboxylic acid; and (c) at least one basic reagent in an amount sufficient to form a water soluble epoxy acrylate resin product.

2. The composition of claim 1, wherein the at least one diepoxide comprises an aliphatic diepoxide, an aryl diepoxide, or mixtures thereof.

3. The composition of claim 1, wherein the at least one diepoxide comprises a divinylarene dioxide.

4. The composition of claim 1, wherein the at least one carboxylic acid comprises acrylic acid, methacrylic acid, cyanoacrylic acid, crotonic acid, alpha-phenylacrylic acid, methoxyacrylic acid, alpha-4-phenylphenylacrylic acid, monomethylester of maleic acid, monomethylester of fumaric acid, 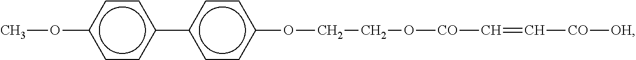
or mixtures thereof.

5. The composition of claim 1, wherein the multi-functional carboxylic acid comprises oxalic acid, malonic acid, succinic acid, glutaric acid, adipic acid, pimelic acid, citric acid, isocitric acid, aconitic acid, propane-1,2,3-tricarboxylic acid, trimesic acid, 1,2,4,5-benzene tetracarboxylic acid and polycarboxylic acid, or mixtures thereof.

6. The composition of claim 1, wherein the basic reagent comprises pyridine, trimethylamine, triethylamine, tricyclohexylphosphine, triphenylphosphine, triethoxyphosphine, or mixtures thereof.

7. A curable water soluble resin composition comprising (i) the water soluble epoxy acrylate resin composition of claim 1; and (ii) at least one initiator.

8. The curable composition of claim 7, wherein the at least one initiator comprises benzophenone-1-hydroxy cyclohexyl phenyl ketone mixture; phenylglyoxylate photoinitiator; or mixtures thereof.

9. A process for preparing a water soluble epoxy acrylate resin composition comprising reacting (a) at least one diepoxide resin; (b) at least one carboxylic acid; and (c) at least one basic reagent in an amount sufficient to form a water soluble epoxy acrylate resin product.

10. A process for preparing a curable water soluble resin composition comprising admixing (i) the water soluble epoxy acrylate resin composition of claim 1; and (ii) at least one initiator.

11. A process for making a cured composite comprising curing the curable water soluble resin composition of claim 7.

12. A cured product made by curing the curable water soluble resin composition of claim 7.
